(19) United States
(12) Patent Application Publication
(10) Pub. No.: US 2021/0312930 A1
(43) Pub. Date: Oct. 7, 2021

(54) COMPUTER SYSTEM, SPEECH RECOGNITION METHOD, AND PROGRAM

(71) Applicant: OPTIM CORPORATION, Saga (JP)

(72) Inventor: Shunji SUGAYA, Tokyo (JP)

(21) Appl. No.: 17/280,626

(22) PCT Filed: Sep. 27, 2018
(86) PCT No.: PCT/JP2018/036001

§ 371 Date: Mar. 26, 2021

(51) Int. Cl. G10L 15/32; G10L 15/22; G10L 15/08; G10L 15/18

(52) U.S. Cl. CPC G10L 15/32; G10L 15/18; G10L 15/083; G10L 15/22

(57) ABSTRACT

Provided are a computer system, and a method and a program for voice recognition that easily improve the accuracy of the result of voice recognition. The computer system acquires voice data; performs voice recognition for the acquired voice data; performs voice recognition for the acquired voice data with an algorithm or a database different from that used by the first recognition unit; and outputs both of the recognition results when the recognition results from the voice recognitions are different. Furthermore, the computer system acquires voice data; performs N-different voice recognitions for the acquired voice data with algorithms or databases different from each other; and outputs only a different recognition result out of the recognition results of the N-different voice recognitions.

### TECHNICAL FIELD

The present disclosure relates to a computer system, and a method and a program for voice recognition that perform voice recognition.

### BACKGROUND

Recently, voice input is actively used in various fields. For example, the voice input to a mobile terminal such as a smart phone or a tablet terminal, a smart speaker, etc., often operates these terminals, information search, and cooperative home electrical appliance. Therefore, there is a growing need for a more accurate voice recognition technology.

As such a voice recognition technology, the composition that combines the results of voice recognition in different models such as an acoustic model and a language model and outputs the final recognition result is disclosed (refer to Patent Document 1).

### Document in the Existing Art

### Patent Document

Patent Document 1: JP 2017-40919 A

### SUMMARY

However, in the composition of Patent Document 1, tha accuracy of voice recognition is not enough because not multiple voice recognition engines but a single voice recognition engine recognizes voices with two or more models.

An objective of the present disclosure is to provide a computer system, and a method and a program for voice recognition that easily improve the accuracy of the result of voice recognition.

The present disclosure provides a computer system including: an acquisition unit that acquires voice data;

a first recognition unit that performs voice recognition for the acquired voice data;

a second recognition unit that performs voice recognition for the acquired voice data with an algorithm or a database different from that used by the first recognition unit; and an output unit that outputs both of the recognition results when the recognition results from the voice recognitions are different.

According to the present disclosure, the computer system acquires voice data; performs voice recognition for the acquired voice data; performs voice recognition for the acquired voice data with an algorithm or a database different from that used by the first recognition unit; and outputs both of the recognition results when the recognition results from the voice recognitions are different.

The present disclosure is the category of a computer system, but the categories of a method, a program, etc. have similar functions and effects.

The present disclosure also provides a computer system including: an acquisition unit that acquires voice data;

an N-different recognition unit that performs N-different voice recognitions for the acquired voice data with algorithms or databases different from each other; and an output unit that outputs only a different recognition result out of the recognition results of the N-different voice recognitions.

According to the present disclosure, the computer system acquires voice data; performs N-different voice recognitions for the acquired voice data with algorithms or databases different from each other; and outputs only a different recognition result out of the recognition results of the N-different voice recognitions.

The present disclosure is the category of a computer system, but the categories of a method, a program, etc. have similar functions and effects.

The present disclosure easily provides a computer system, and a method and a program for voice recognition that easily improve the accuracy of the result of voice recognition.

### BRIEF DESCRIPTION OF THE DRAWINGS

FIG. 1 is a schematic diagram of the system for voice recognition 1.

FIG. 2 is an overall configuration diagram of the system for voice recognition 1.

FIG. 3 is a flow chart illustrating the first voice recognition process performed by the computer 10.

FIG. 4 is a flow chart illustrating the second voice recognition process performed by the computer 10.

FIG. 5 shows the state in which the computer 10 instructs a user terminal to output recognition result data on its display unit.

FIG. 6 shows the state in which the computer 10 instructs a user terminal to output recognition result data on its display unit.

FIG. 7 shows the state in which the computer 10 instructs a user terminal to output recognition result data on its display unit.

### DETAILED DESCRIPTION

Embodiments of the present disclosure will be described below with reference to the attached drawings. However, this is illustrative only, and the technological scope of the present disclosure is not limited thereto.

### Overview of System for Voice Recognition 1

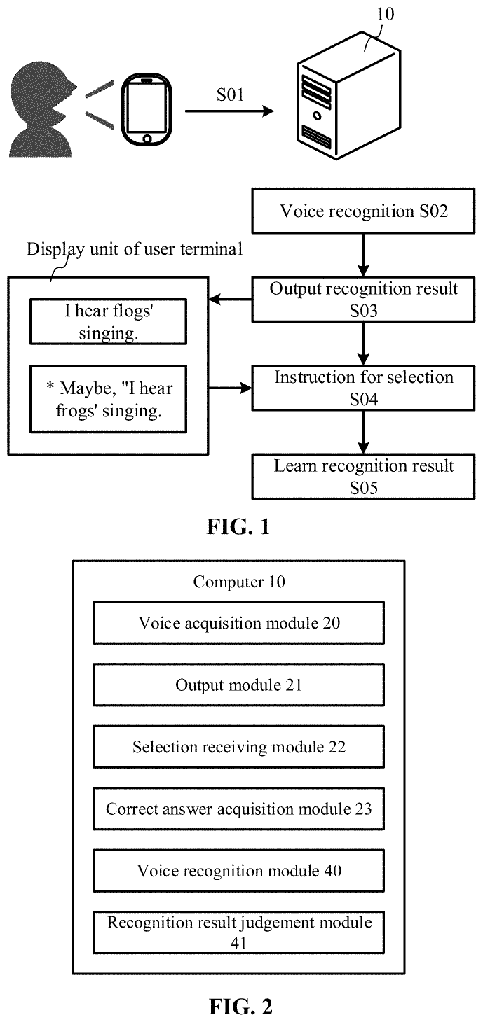

A preferable embodiment of the present disclosure is described below with reference to FIG. 1. FIG. 1 shows an overview of the system for voice recognition 1 according to a preferable embodiment of the present disclosure. The system for voice recognition 1 is a computer system including a computer 10 to perform voice recognition.

The system for voice recognition 1 may include other terminals such as a user terminal (e.g., a mobile terminal, a smart speaker) owned by a user.

The computer 10 acquires a voice pronounced from a user as voice data. The voice data is acquired by collecting a voice pronounced by a user with a voice collecting device such as a microphone. The user terminal transmits the collected voice to the computer 10 as voice data. The computer 10 acquires the voice data by receiving it.

The computer 10 performs voice recognition for the acquired voice data with a first voice analysis engine. The computer 10 also performs voice recognition for the acquired voice data with a second voice analysis engine at the same time. This first voice analysis engine and the second voice analysis engine each use a different algorithm or database.

The computer 10 instructs the user terminal to output both of the recognition results when the recognition result from the first voice analysis engine is different from the recognition result from the second voice analysis engine. The user terminal notifies the user of both of the recognition results by displaying them on its display unit, etc., or outputting them from a speaker, etc. As the result, the computer 10 notifies the user of both of the recognition results.

The computer 10 instructs the user terminal to receive the user's selection of a correct recognition result from the both of the output recognition results. The user terminal receives a selection of the correct recognition result by an input such as a tap operation for the displayed recognition results. The user terminal also receives a selection of the correct recognition result from for the output recognition results by a voice input. The user terminal transmits the selected recognition result to the computer 10. The computer 10 acquires the correct recognition result selected by the user by receiving the selected recognition result. As the result, the computer 10 receives a selection of the correct recognition result.

The computer 10 instructs the first voice analysis engine or the second voice analysis engine that outputs a recognition result not selected as the correct recognition result to learn the selected correct recognition result. For example, if the recognition result from the first voice analysis engine is selected as the correct recognition result, the computer 10 instructs the second voice analysis engine to learn the recognition result from the first voice analysis engine.

The computer 10 performs voice recognition for the acquired voice data with N-different voice analysis engines. The N-different voice analysis engines each use a different algorithm or database.

The computer 10 instructs the user terminal to output a different recognition result from the N-different voice analysis engines. The user terminal notifies the user of the different recognition result by displaying them on its display unit, etc., or outputting them from a speaker, etc. As the result, the computer 10 notifies the user of different recognition results out of the recognition from N-different voice analysis engines.

The computer 10 instructs the user terminal to receive the user's selection of a correct recognition result from the different recognition results. The user terminal receives a selection of the correct recognition result by an input such as a tap operation for the displayed recognition results. The user terminal also receives a selection of the correct recognition result from the output recognition results by a voice input. The user terminal transmits the selected recognition result to the computer 10. The computer 10 acquires the correct recognition result selected by the user by receiving the selected recognition result. As the result, the computer 10 receives a selection of the correct recognition result.

The computer 10 instructs the voice analysis engine that has output a recognition result not selected as the correct recognition result to learn the selected correct recognition result. For example, if the recognition result from the first voice analysis engine is selected as the correct recognition result, the computer 10 instructs the other voice analysis engines to learn the recognition result from the first voice analysis engine.

The overview of the process that the system for voice recognition 1 performs is described below.

The computer 10 acquires voice data (Step S01). The computer 10 acquires a voice input to a user terminal received as voice data. For example, the user terminal collects a voice pronounced by the user with the sound collecting device built in the user terminal and transmits the collected voice to the computer 10 as voice data. The computer 10 acquires the voice data by receiving it.

The computer 10 performs voice recognition for the voice data with a first voice analysis engine and a second voice analysis engine (Step S02). The first voice analysis engine and the second voice analysis engine each use a different algorithm or database. The computer 10 performs two voice recognitions for one voice data. For example, the computer 10 recognizes the voice with a spectrum analyzer, etc., based on the voice waveform. The computer 10 uses the voice analysis engines provided from different providers or the voice analysis engines of different kinds of software to perform the voice recognition. The computer 10 converts the voice into the text of the recognition result as the result of each of the voice recognitions.

The computer 10 instructs the user terminal to output both of the recognition results when the recognition result from the first voice analysis engine is different from the recognition result from the second voice analysis engine (Step S03). The computer 10 instructs the user terminal to output the text of the both of the recognition results. The user terminal displays the both of the recognition results on its display unit or outputs them by voice. The text of the recognition result contains a text that has the user analogize that the recognition result is different.

The computer 10 instructs the user terminal to receive the user's selection of a correct recognition result from the both of the recognition results output from the user terminal (Step SO4). The computer 10 instructs the user terminal to receive a selection of the correct answer to the recognition results by a tap operation or a voice input from the user. For example, the computer 10 instructs the user terminal to receive a selection of the correct answer to the recognition results by receiving a selection operation for any one of the texts displayed on the user terminal.

The computer 10 instructs the voice analysis engine that has output a recognition result not selected by the user as the correct recognition result as the voice analysis engine that has performed incorrect voice recognition to learn the selected correct recognition result as correct answer data (Step S05). If the recognition result from the first voice analysis engine is correct answer data, the computer 10 instructs the second voice analysis engine to learn this correct answer data. If the recognition result from the second voice analysis engine is correct answer data, the computer 10 instructs the first voice analysis engine to learn this correct answer data.

The computer 10 may perform voice recognition with three or more N-different voice analysis engines without limitation to two voice analysis engines. The N-different voice analysis engines each use a different algorithm or database. In this case, the computer 10 performs voice recognition for the acquired voice data with N-different voice analysis engines. The computer 10 performs N-different voice recognitions for one voice data. The computer 10 converts the voice into the text of the recognition result as the result of the N-different voice recognitions.

The computer 10 instructs the user terminal to output a different recognition result from the N-different voice analysis engines. The computer 10 instructs the user terminal to output the text of a different recognition result. The user terminal displays the different recognition result on its display unit or outputs them by voice. The text of the recognition result contains a text that has the user analogize that the recognition result is different.

The computer 10 instructs the user terminal to receive the user's selection of a correct recognition result from the recognition results output from the user terminal. The computer 10 instructs the user terminal to receive a selection of the correct answer to the recognition results by a tap operation or a voice input from the user. The computer 10 instructs the user terminal to receive a selection of the correct answer to the recognition results by receiving a selection operation for any one of the texts displayed on the user terminal.

The computer 10 instructs the voice analysis engine that has output a recognition result not selected by the user as the correct recognition result as the voice analysis engine that has performed incorrect voice recognition to learn the selected correct recognition result as correct answer data.

### System Configuration of System for Voice Recognition 1

A system configuration of the system for voice recognition 1 according to a preferable embodiment is described below with reference to FIG. 2. FIG. 2 is a block diagram illustrating the system for voice recognition 1 according to a preferable embodiment of the present disclosure. In FIG. 2, the system for voice recognition 1 is a computer system including a computer 10 to perform voice recognition.

The system for voice recognition 1 may include other terminals such as user terminals not shown in the drawings.

The computer 10 is data-communicatively connected with a user terminal not shown in the drawings through a public line network, etc., to transceive necessary data and performs voice recognition, as described above.

The computer 10 includes a central processing unit (hereinafter referred to as “CPU”), a random access memory (hereinafter referred to as “RAM”), and a read only memory (hereinafter referred to as “ROM”); and a communication unit such as a device that is capable to communicate with a user terminal and other computers 10, for example, a Wireless Fidelity or Wi-Fi® enabled device complying with IEEE 802.11. The computer 10 also includes a memory unit such as a hard disk, a semiconductor memory, a record medium, or a memory card to store data. The computer 10 also includes a processing unit provided with various devices that perform various processes.

In the computer 10, the control unit reads a predetermined program to achieve a voice acquisition module 20, an output module 21, a selection receiving module 22, and a correct answer acquisition module 23 in cooperation with the communication unit. Furthermore, in the computer 10, the control unit reads a predetermined program to achieve a voice recognition module 40 and a recognition result judgement module 41 in cooperation with the processing unit.

### First Voice Recognition Process

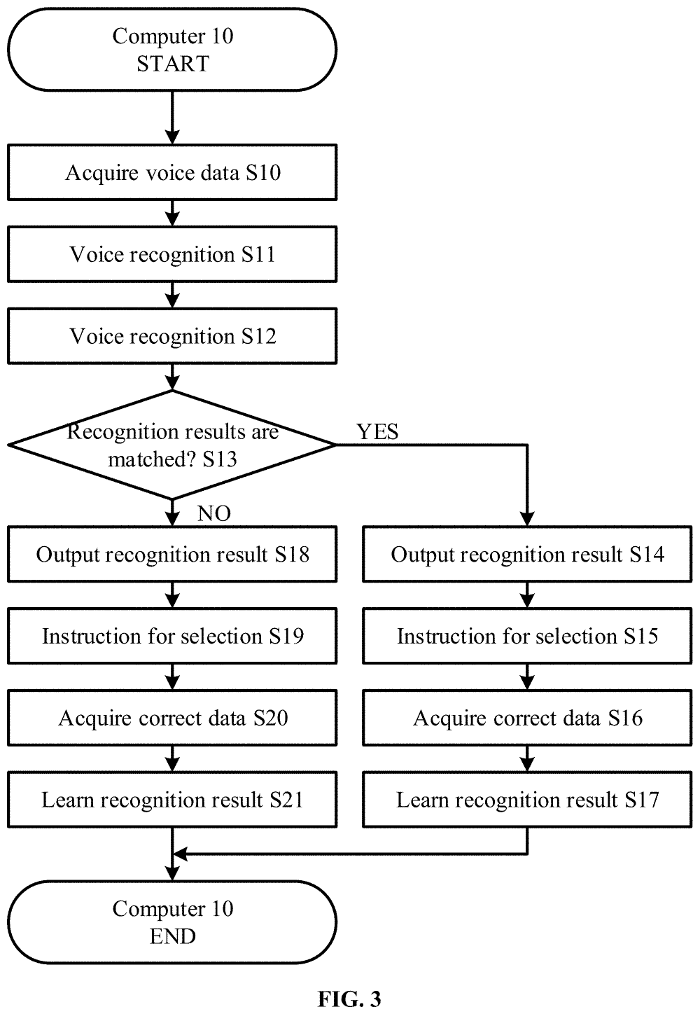

The first voice recognition process performed by the system for voice recognition 1 is described below with reference to FIG. 3. FIG. 3 is a flow chart illustrating the first voice recognition process performed by the computer 10. The tasks executed by the modules are described below with this process.

The voice acquisition module 20 acquires voice data (Step S10). In Step S10, the voice acquisition module 20 acquires a voice input to a user terminal received as voice data. The user terminal collects a voice pronounced by a user with a voice collecting device built in the user terminal. The user terminal transmits the collected voice to the computer 10 as voice data. The voice acquisition module 20 acquires the voice by receiving the voice data.

The voice recognition module 40 performs voice recognition for the voice data with a first voice analysis engine (Step S11). In Step S11, the voice recognition module 40 recognizes the voice based on the voice waveform produced by a spectrum analyzer, etc. The voice recognition module 40 converts the recognized voice into a text. This text is referred to as a first recognition text. Specifically, the recognition result from the first voice analysis engine is the first recognition text.

The voice recognition module 40 performs voice recognition for the voice data with a second voice analysis engine (Step S12). In Step S12, the voice recognition module 40 recognizes the voice based on the voice waveform produced by a spectrum analyzer, etc. The voice recognition module 40 converts the recognized voice into a text. This text is referred to as a second recognition text. Specifically, the recognition result from the second voice analysis engine is the second recognition text.

The first voice analysis engine and the second voice analysis engine that are described above each use a different algorithm or database. As the result, the voice recognition module 40 performs two voice recognitions based on one voice data. The first voice analysis engine and the second voice analysis engine each use a voice analysis engine provided from a different provider or a voice analysis engine of a different kind of software to perform the voice recognition.

The recognition result judgement module 41 judges if the recognition results are matched (Step S13). In the step S13, the recognition result judgement module 41 judges if the first recognition text is matched with the second recognition text.

In Step S13, if the recognition result judgement module 41 judges that the recognition results are matched (Step S13, YES), the output module 21 instructs the user terminal to output any one of the first recognition text and the second recognition text as recognition result data (Step S14). In Step S14, the output module 21 instructs the user terminal to output only any one of the recognition results from the voice analysis engines as recognition result data. In this example, the output module 21 instructs the user terminal to output the first recognition text as recognition result data.

The user terminal receives the recognition result data and displays the first recognition text on its display unit based on the recognition result data. Alternatively, the user terminal outputs a voice based on the first recognition text from its speaker based on the recognition result data.

The selection receiving module 22 instructs the user terminal to receive a selection when the first recognition text is a correct recognition result or when the first recognition text is an incorrect recognition result (Step S15). In Step S15, the selection receiving module 22 instructs the user terminal to receive a selection of a correct or incorrect recognition result by receiving a tap operation or a voice input from the user. If the correct recognition result is selected, the selection receiving module 22 instructs the user terminal to receive a selection of the correct recognition result. On the other hand, if an incorrect recognition result is selected, the selection receiving module 22 instructs the user terminal to receive a selection of the incorrect recognition result and then receive the correct recognition result (correct text) by receiving a tap operation or a voice input from the user.

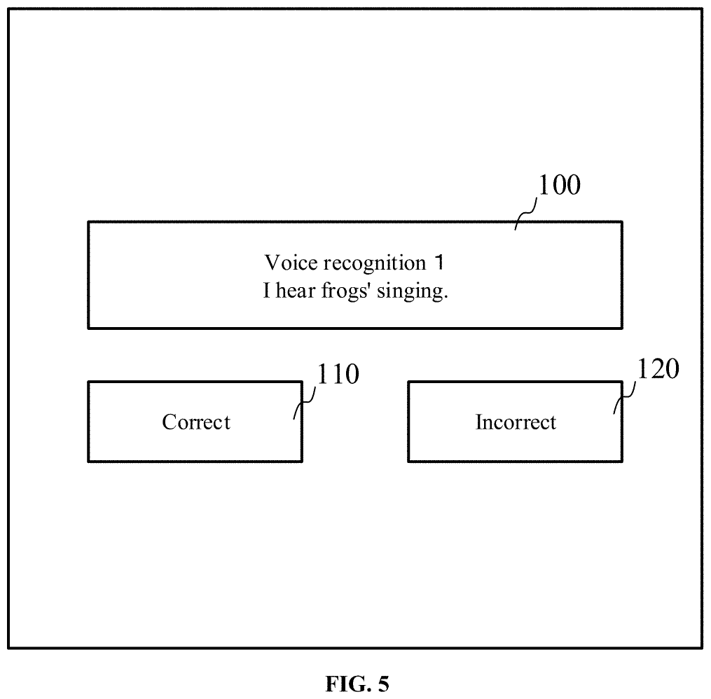

FIG. 5 shows the state in which the user terminal displays recognition result data on its display unit. In FIG. 5, the user terminal displays a recognition text display field 100, a correct answer icon 110, and an incorrect answer icon 120. The recognition text display field 100 displays the text of a recognition result. Specifically, the recognition text display field 100 displays the first recognition text “I hear frogs' singing.”

The selection receiving module 22 instructs the user terminal to receive a selection of which the first recognition text is a correct recognition result or an incorrect recognition result by receiving an input to the correct answer icon 110 or the incorrect answer icon 120. If the correct recognition result is selected, the selection receiving module 22 instructs the user terminal to receive an input to the correct answer icon 110 as the operation for the correct recognition result. On the other hand, if the recognition result is incorrect, the selection receiving module 22 instructs the user terminal to receive an input to the correct answer icon 110 from the user as the operation for the incorrect recognition result. If the incorrect answer icon 120 receives an input, the selection receiving module 22 instructs the user terminal to receive an input of the correct text as the correct recognition result

The correct answer acquisition module 23 acquires the selected correct or incorrect recognition result as correct answer data (Step S16). In Step S16, the correct answer acquisition module 23 acquires correct answer data by receiving correct answer data transmitted from the user terminal.

The voice recognition module 40 instructs the voice analysis engine to learn the correct or incorrect recognition result based on the correct answer data (Step S17). In Step S17, if the voice recognition module 40 acquires the correct recognition result as correct answer data, the voice recognition module 40 instructs the first voice analysis engine and the second voice analysis engine to learn that the recognition result is correct. On the other hand, if the voice recognition module 40 acquires the incorrect recognition result as correct answer data, the voice recognition module 40 instructs the first voice analysis engine and the second voice analysis engine to learn the correct text received as the correct recognition result.

In Step S13, if the recognition result judgement module 41 judges that the recognition results are not matched (Step S13, NO), the output module 21 instructs the user terminal to output both of the first recognition text and the second recognition text as recognition result data (Step S18). In Step S18, the output module 21 instructs the user terminal to output both of the recognition results from the voice analysis engines as recognition result data. In the recognition result data, the text that has the user analogize that the recognition result is different (an expression recognizing possibility, such as “perhaps” or “maybe”) is contained in any one of the recognition text. In this example, the output module 21 contains the text that has the user analogize that the recognition result is different in the second recognition text.

The user terminal receives the recognition result data and displays the first recognition text and the second recognition text on its display unit based on the recognition result data. Alternatively, the user terminal outputs a voice based on the first recognition text and the second recognition text from its speaker based on the recognition result data.

The selection receiving module 22 instructs the user terminal to receive the user's selection of a correct recognition result from the recognition results output from the user terminal (Step S19). In Step S19, the selection receiving module 22 instructs the user terminal to receive a selection of which recognition text is the correct recognition result by receiving a tap operation or a voice input. The selection receiving module 22 instructs the user terminal to receive a selection (e.g., a tap, a voice input) of the correct recognition text of the correct recognition result.

If there are no correct recognition results, the selection receiving module 22 instructs the user terminal to receive a selection of the incorrect recognition result and then receive the correct recognition result (correct text) by receiving a tap operation or a voice input from the user.

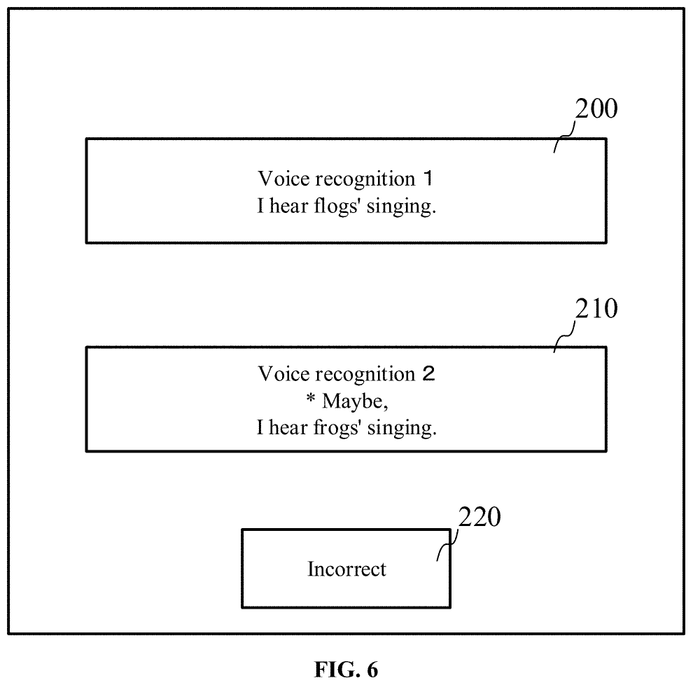

FIG. 6 shows the state in which the user terminal displays recognition result data on its display unit. In FIG. 6, the user terminal displays a first recognition text display field 200, a second recognition text display field 210, and an incorrect answer icon 220. The first recognition text display field 200 displays the first recognition text. The second recognition text display field 210 displays the second recognition text. The second recognition text contains a text that has the user analogize that the recognition result is different from the above-mentioned first recognition text. Specifically, the first recognition text display field 200 displays the first recognition text “I hear flogs' singing.” The second recognition text display field 210 also displays “*Maybe, “I hear frogs' singing.”

The selection receiving module 22 instructs the user terminal to receive a selection of which the first recognition text or the second recognition text is the correct recognition result by receiving an input to any one of the first recognition text display field 200 and the second recognition text display field 210. If the first recognition text is the correct recognition result, the selection receiving module 22 instructs the user terminal to receive a selection by a tap operation or a voice input to the first recognition text display field 200. If the second recognition text is the correct recognition result, the selection receiving module 22 instructs the user terminal to receive a selection by a tap operation or a voice input to the second recognition text display field 210. If both of the first recognition text and the second recognition text are incorrect, the selection receiving module 22 instructs the user terminal to receive a selection to the incorrect answer icon 220 as a selection of the incorrect recognition result. If the incorrect answer icon 220 receives a selection, the selection receiving module 22 instructs the user terminal to receive an input of the correct text as the correct recognition result.

The correct answer acquisition module 23 acquires the selected correct recognition result as correct answer data (Step S20). In Step S20, the correct answer acquisition module 23 acquires correct answer data by receiving correct answer data transmitted from the user terminal.

The voice recognition module 40 instructs the voice analysis engine not output the selected correct recognition result to learn this selected correct recognition result based on the correct answer data (Step S21). In Step S21, if the correct answer is the first recognition text, the voice recognition module 40 instructs the second voice analysis engine to learn the first recognition text as the correct recognition result and also instructs the first voice analysis engine to learn that the recognition result is correct. If the correct answer is the second recognition text, the voice recognition module 40 instructs the first voice analysis engine to learn the second recognition text as the correct recognition result and also instructs the second voice analysis engine to learn that the recognition result is correct. On the other hand, if the correct answer is not the first recognition text or the second recognition text, the voice recognition module 40 instructs the first voice analysis engine and the second voice analysis engine to learn the correct text received as the correct recognition result.

The voice recognition module 23 uses the first voice analysis engine and the second voice analysis engine that have added the learning result for the voice recognition next time.

### Second Voice Recognition Process

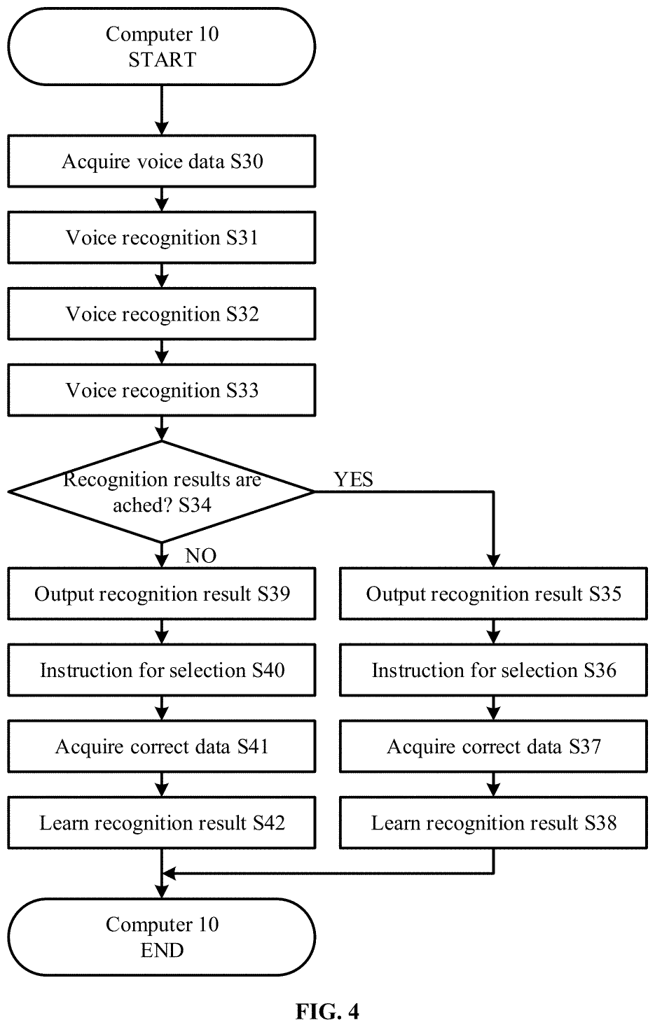

The second voice recognition process performed by the system for voice recognition 1 is described below with reference to FIG. 4. FIG. 4 is a flow chart illustrating the second voice recognition process performed by the computer 10. The tasks executed by the modules are described below with this process.

The detailed explanation of the tasks similar to those of the first voice recognition process is omitted. The difference between the first voice recognition process and the second voice recognition process is the total number of the voice analysis engines that the voice recognition module 40 uses.

The voice acquisition module 20 acquires voice data (Step S30). The step S30 is processed in the same way as the above-mentioned step S10.

The voice recognition module 40 performs voice recognition for the voice data with a first voice analysis engine (Step S31). The step S31 is processed in the same way as the above-mentioned step S11.

The voice recognition module 40 performs voice recognition for the voice data with a second voice analysis engine (Step S32). The step S32 is processed in the same way as the above-mentioned step S12.

The voice recognition module 40 performs voice recognition for the voice data with a third voice analysis engine (Step S33). In Step S33, the voice recognition module 40 recognizes the voice based on the voice waveform produced by a spectrum analyzer, etc. The voice recognition module 40 converts the recognized voice into a text. This text is referred to as a third recognition text. Specifically, the recognition result from the third voice analysis engine is the third recognition text.

The first voice analysis engine, the second voice analysis engine, and the third voice analysis engine that are described above each use a different algorithm or database. As the result, the voice recognition module 40 performs three voice recognitions based on one voice data. The first voice analysis engine, the second voice analysis engine, and the third voice analysis engine each use a voice analysis engine provided from a different provider or a voice analysis engine of a different kind of software to perform the voice recognition.

The above-mentioned process performs voice recognition with three voice analysis engines. However, the number of voice analysis engines may be N more than three. In this case, the N-different voice analysis engines each recognize a voice with a different algorithm or database. If N-different voice analysis engines are used, the process described later is performed for N-different recognition texts in the process described later.

The recognition result judgement module 41 judges if the recognition results are matched (Step S34). In the step S34, the recognition result judgement module 41 judges if the first recognition text is matched with the second recognition text and the third recognition text.

In Step S34, if the recognition result judgement module 41 judges that the recognition results are matched (Step S34, YES), the output module 21 instructs the user terminal to output any one of the first recognition text, the second recognition text, and the third recognition text as recognition result data (Step S35). The process of the step S35 is approximately same as that of the above-mentioned step S14. The difference is that the third recognition text is included. In this example, the output module 21 instructs the user terminal to output the first recognition text as recognition result data.

The user terminal receives the recognition result data and displays the first recognition text on its display unit based on the recognition result data. Alternatively, the user terminal outputs a voice based on the first recognition text from its speaker based on the recognition result data.

The selection receiving module 22 instructs the user terminal to receive a selection when the first recognition text is a correct recognition result or when the first recognition text is an incorrect recognition result (Step S36). The step S36 is processed in the same way as the above-mentioned step S15.

The correct answer acquisition module 23 acquires the selected correct or incorrect recognition result as correct answer data (Step S37). The step S37 is processed in the same way as the above-mentioned step S16.

The voice recognition module 40 instructs the voice analysis engine to learn the correct or incorrect recognition result based on the correct answer data (Step S38). In Step S38, if the voice recognition module 40 acquires the correct recognition result as correct answer data, the voice recognition module 40 instructs the first voice analysis engine, the second voice analysis engine, and the third voice analysis engine to learn that the recognition result is correct. On the other hand, if the voice recognition module 40 acquires the incorrect recognition result as correct answer data, the voice recognition module 40 instructs the first voice analysis engine, the second voice analysis engine, and the third voice analysis engine to learn the correct text received as the correct recognition result.

In Step S34, if the recognition result judgement module 41 judges that the recognition results are not matched (Step S34, NO), the output module 21 instructs the user terminal to output only a different recognition result out of the first recognition text, the second recognition text, and the third recognition text as recognition result data (Step S39). In Step S39, the output module 21 instructs the user terminal to output only a different recognition results out of the recognition results from the voice analysis engines as recognition result data. The recognition result data contains a text that has the user analogize that the recognition result is different.

For example, if the first recognition text, the second recognition text, and the third recognition text are different, the output module 21 instructs the user terminal to output these three recognition texts as recognition result data. At this time, the second recognition text and the third recognition text contain a text that has the user analogize that the recognition result is different

For example, if the first recognition text and the second recognition text are the same but different from the third recognition text, the output module 21 instructs the user terminal to output the first recognition text and the third recognition text as recognition result data. At this time, the third recognition text contains a text that has the user analogize that the recognition result is different. For example, if the first recognition text and the third recognition text are the same but different from the second recognition text, the output module 21 instructs the user terminal to output the first recognition text and the second recognition text as recognition result data. At this time, the second recognition text contains a text that has the user analogize that the recognition result is different. For example, if the second recognition text and the third recognition text are the same but different from the first recognition text, the output module 21 instructs the user terminal to output the first recognition text and the second recognition text as recognition result data. At this time, the second recognition text contains a text that has the user analogize that the first recognition text and the recognition result is different. Thus, in the recognition result data, the recognition text with the highest agreement rate (the agreement rate of the recognition results from two or more voice analysis engines) is output as a recognition text as it is, and the other recognition texts are output, including the text that has the user analogize that the recognition result is different. The same things go for other combinations even if the number of voice analysis engines is four or more.

In this example, the output module 21 is described when all of the recognition texts are different, and when the first recognition text and the second recognition text are same but different from the third recognition text.

The user terminal receives the recognition result data and displays the first recognition text, the second recognition text, and the third recognition text on its display unit based on the recognition result data. Alternatively, the user terminal outputs a voice based on the first recognition text, the second recognition text, and the third recognition text from its speaker based on the recognition result data.

The user terminal receives the recognition result data and displays the first recognition text and the third recognition text on its display unit based on the recognition result data. Alternatively, the user terminal outputs a voice based on the first recognition text and the third recognition text from its speaker based on the recognition result data.

The selection receiving module 22 instructs the user terminal to receive the user's selection of a correct recognition result from the recognition results output from the user terminal (Step S40). The step S40 is processed in the same way as the above-mentioned step S19.

An example where the user terminal displays the first recognition text, the second recognition text, and the third recognition text on its display unit.

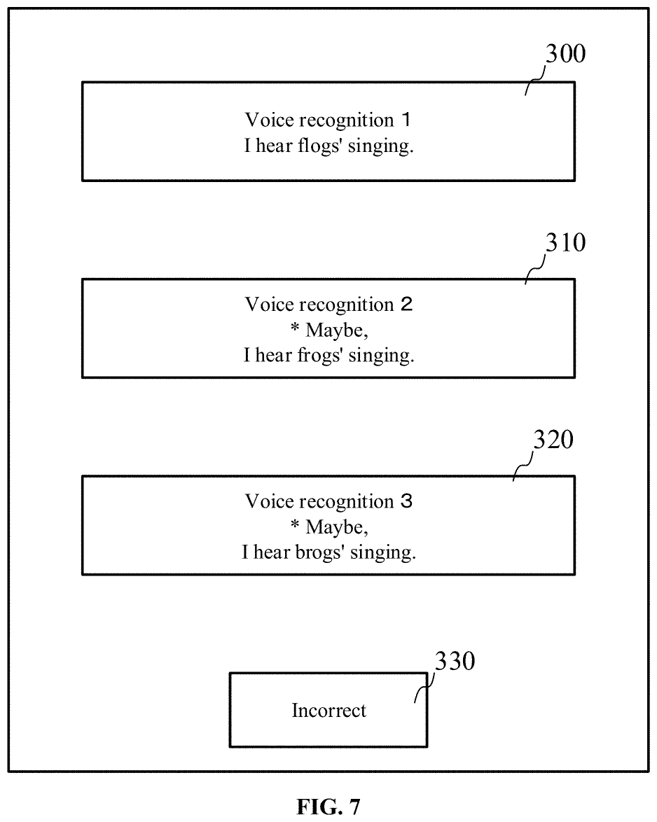

FIG. 7 shows the state in which the user terminal displays recognition result data on its display unit. In FIG. 7, the user terminal displays a first recognition text display field 300, a second recognition text display field 310, a third recognition text display field 320, and an incorrect answer icon 330. The first recognition text display field 300 displays the first recognition text. The second recognition text display field 310 displays the second recognition text. The second recognition text contains a text that has the user analogize that the recognition result is different from the above-mentioned first recognition text and third recognition text. The third recognition text display field 320 displays the third recognition text. The third recognition text contains a text that has the user analogize that the recognition result is different from the above-mentioned first recognition text and second recognition text. Specifically, the first recognition text display field 300 displays the first recognition text “I hear flogs' singing.” The second recognition text display field 310 displays “*Maybe, “I hear frogs' singing.” The third recognition text display field 320 displays “*Maybe, “I hear brogs' singing.”

The selection receiving module 22 instructs the user terminal to receive a selection of which the first recognition text, the second recognition text, or the third recognition text is the correct recognition result by receiving an input to any one of the first recognition text display field 300, the second recognition text display field 310, and the third recognition text display field 320. If the first recognition text is the correct recognition result, the selection receiving module 22 instructs the user terminal to receive a selection by a tap operation or a voice input to the first recognition text display field 300. If the second recognition text is the correct recognition result, the selection receiving module 22 instructs the user terminal to receive a selection by a tap operation or a voice input to the second recognition text display field 310. If the third recognition text is the correct recognition result, the selection receiving module 22 instructs the user terminal to receive a selection by a tap operation or a voice input to the third recognition text display field 320. If all of the first recognition text, the second recognition text, and the third recognition text are incorrect, the selection receiving module 22 instructs the user terminal to receive a selection to the incorrect answer icon 330 as an operation of the incorrect recognition result. If the incorrect answer icon 330 receives a selection, the selection receiving module 22 instructs the user terminal to receive an input of the correct text as the correct recognition result.

The explanation of an example where the user terminal displays the first recognition text and the third recognition text on its display unit is omitted because this example is similar to the above-mentioned example of FIG. 6. The difference is that the second recognition text display field 210 displays the third recognition text. [0089]

The correct answer acquisition module 23 acquires the selected correct recognition result as correct answer data (Step S41). The step S41 is processed in the same way as the above-mentioned step S20.

The voice recognition module 40 instructs the voice analysis engine not output the selected correct recognition result to learn this selected correct recognition result based on the correct answer data (Step S42). In Step S42, if the correct answer is the first recognition text, the voice recognition module 40 instructs the second voice analysis engine and the third voice analysis engine to learn the first recognition text as the correct recognition result and also instructs the first voice analysis engine to learn that the recognition result is correct. If the correct answer is the second recognition text, the voice recognition module 40 instructs the first voice analysis engine and the third voice analysis engine to learn the third recognition text as the correct recognition result and also instructs the second voice analysis engine to learn that the recognition result is correct. If the correct answer is the third recognition text, the voice recognition module 40 instructs the first voice analysis engine and the second voice analysis engine to learn the third recognition text as the correct recognition result and also instructs the third voice analysis engine to learn that the recognition result is correct. On the other hand, if the correct answer is not the first recognition text, the second recognition text, or the third recognition text, the voice recognition module 40 instructs the first voice analysis engine, the second voice analysis engine, and the third recognition text to learn the correct text received as the correct recognition result.

The system for voice recognition 1 may perform the process similar to the process for three voice analysis engines for N-different voice analysis engines. Specifically, the system for voice recognition 1 instructs the user terminal to output only a different voice recognition result out of the N-different voice recognition results and receive the user's selection of the correct voice recognition from these output recognition results. The system for voice recognition 1 learns the selected correct voice recognition result when the output voice recognition result is incorrect.

To achieve the means and the functions that are described above, a computer (including a CPU, an information processor, and various terminals) reads and executes a predetermined program. For example, the program may be provided through Software as a Service (SaaS), specifically, from a computer through a network or may be provided in the form recorded in a computer-readable medium such as a flexible disk, CD (e.g., CD-ROM), or DVD (e.g., DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present disclosure are described above. However, the present disclosure is not limited to the above-mentioned embodiments. The effect described in the embodiments of the present disclosure is only the most preferable effect produced from the present disclosure. The effects of the present disclosure are not limited to those described in the embodiments of the present disclosure.

### DESCRIPTION OF REFERENCE NUMBERS

1 System for voice recognition

10 Computer

1.-8. (canceled)

9. A computer system comprising:
an acquisition unit configured to acquire voice data;
an N-different recognition unit configured to perform N-different voice recognitions for the acquired voice data with algorithms or databases different from each other;
an output unit configured to output only a different recognition result out of the recognition results of the N-different voice recognitions; and
a selection unit configured to provide an instruction to receive the user's selection of a correct recognition result from the output recognition results, wherein
the N-different recognition units are configured to learn the correct recognition result when the recognized result is are not selected as the correct recognition result.

10. A method for voice recognition that a computer system executes, comprising the steps of:
acquiring voice data;
performing N-different voice recognitions for the acquired voice data with algorithms or databases different from each other;
outputting only a different recognition result out of the recognition results of the N-different voice recognitions; and
providing an instruction to receive the user's selection of a correct recognition result from the output recognition results, wherein
the step of performing N-different voice recognitions includes learning the correct recognition result when the recognized result is are not selected as the correct recognition result.

11. A computer readable program for causing a computer system to execute the steps of:
acquiring voice data;
performing N-different voice recognitions for the acquired voice data with algorithms or databases different from each other;
outputting only a different recognition result out of the recognition results of the N-different voice recognitions; and
providing an instruction to receive the user's selection of a correct recognition result from the output recognition results, wherein
the step of performing N-different voice recognitions includes learning the correct recognition result when the recognized result is are not selected as the correct recognition result.
